(19) United States
(12) Patent Application Publication
(10) Pub. No.: US 2008/0016065 A1
(43) Pub. Date: Jan. 17, 2008

(54) DOCUMENT SEARCH SYSTEM, DOCUMENT SEARCH PROCESSING METHOD, AND DOCUMENT SEARCH PROCESSING PROGRAM

(75) Inventors: Motoyuki TAKAAI, Ashigarakami-gun (JP); Hiroshi Masuichi, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/692,252

(22) Filed: Mar. 28, 2007

(30) Foreign Application Priority Data
Jul. 14, 2006 (JP) 2006-194923

(51) Int. Cl. G06F 17/30

(52) U.S. Cl. 707/6; 707/E17.014

(57) ABSTRACT

A document search system includes: a first acquiring portion that acquires a first medical finding; a first searching portion that searches past report information for a second medical finding similar to the first medical finding acquired by the first acquiring portion, the past report information including the second medical finding and a corresponding word of the second medical finding, which is a word defined for the second medical finding; a second searching portion that searches for document information that includes the corresponding word of the second medical finding included in the past report information searched by the first searching portion, the document information being a medical evidence of the first medical finding; and a display controller that displays on a display portion, the document information searched by the second searching portion.

### BACKGROUND

1. Technical Field

This invention relates to a document search system, a document search processing method, and a document search processing program that support editing medical documents such as an electronic card and a radiogram interpretation report.

2. Related Art

A medical doctor gives a diagnosis based on symptoms, laboratory values, and medical findings of a patient. As a technique to support giving the diagnosis, the diagnosis is made by displaying information necessary for giving the diagnosis based on information acquired by a physical examination by the medical doctor. Further, as a technique for standardizing medical findings, there is a technique of supporting standardizing an expression of an input medical finding by displaying supplementary information of the input medical finding and editing the medical finding according to the supplementary information by the medical doctor when the medical finding is prepared.

In these years, there is a tendency to use a system to deal with a clinical text such as an electronic card system. Some of those systems have a full text search function for past clinical texts. With the use of such a full text search function, the medical doctor can search for past clinical results. For example, in another technique, similar cases and diagnoses are searched out of past case information by using a symptom as a search key.

In recent years, Evidence Based Medicine (EBM) has been proposed. Accordingly, it is increasingly necessary that a medical finding by a medical doctor is made based on medical evidence backed up with a medical thesis or the like. Such a medical evidence can be acquired by searching for a medical technical book, a medical thesis, a medical journal or the like, or using a medical thesis search system on the Internet.

In clinical sites, even the identical diseases may result in medical findings different from each other according to the disease region, the patient individual difference and the like. However, it is not the fact that medical theses and the like list up all medical findings for a certain disease. In addition, a word used for describing the medical finding may be varied according to each medical doctor. Therefore, even when search is made by using the word in the medical finding as a keyword, a useful document is not output in some cases. Thus, it has been necessary for medical doctors to take a labored measure such as changing the keyword used for the search.

### SUMMARY

According to an aspect of the present invention, there is provided a document search system including: a first acquiring portion that acquires a first medical finding; a first searching portion that searches past report information for a second medical finding similar to the first medical finding acquired by the first acquiring portion, the past report information including the second medical finding and a corresponding word of the second medical finding, which is a word defined for the second medical finding; a second searching portion that searches for document information that includes the corresponding word of the second medical finding included in the past report information searched by the first searching portion, the document information being a medical evidence of the first medical finding; and a display controller that displays on a display portion, the document information searched by the second searching portion.

### BRIEF DESCRIPTION OF THE DRAWINGS

Exemplary embodiments of the present invention will be described in detail based on the following figures, wherein:

FIG. 1 is a diagram showing a hardware configuration of a document search system;

FIG. 2 shows a first functional block diagram of the document search system;

FIG. 3 is a flowchart showing operations of the document search system;

FIG. 4 is a diagram showing a first example of past report information;

FIGS. 5A and 5B are diagrams showing an example of thesauruses;

FIG. 6 is a diagram showing an example of bilingual dictionaries;

FIG. 7 is a diagram showing a first example of screen transition;

FIG. 8 is a diagram showing a second example of the screen transition;

FIG. 9 is a diagram showing a third example of the screen transition;

FIG. 10 is a diagram showing a fourth example of the screen transition;

FIG. 11 is a diagram showing a fifth example of the screen transition;

FIG. 12 is a diagram showing a second example of the past report information;

FIG. 13 shows a second functional block diagram of the document search system; and

FIG. 14 shows a third functional block diagram of the document search system.

### DETAILED DESCRIPTION

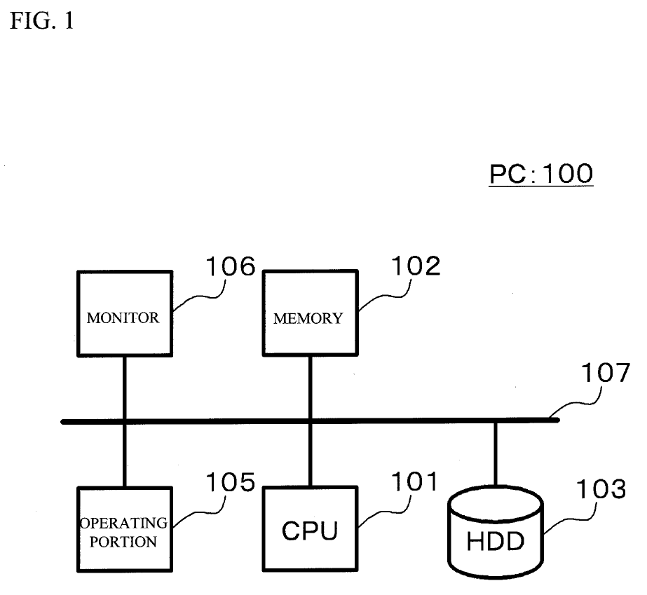

A description will be hereinafter given of an exemplary embodiment of the invention with reference to the drawings. FIG. 1 is a diagram showing a hardware configuration of a personal computer (PC) as a document search system. A PC 100 as the document search system shown in FIG. 1 includes: a CPU 101 connected to an internal bus 107; a memory 102; a hard disc drive (HDD) 103; an operating portion 105 including an input device such as a keyboard and an indicating device such as a mouse; and a monitor 106 for displaying display information on a display screen.

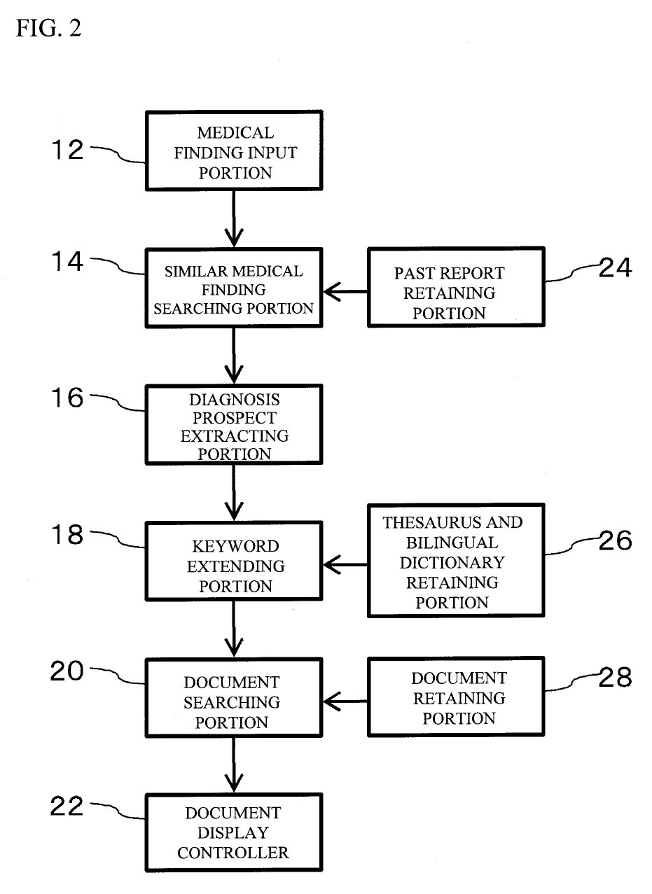

FIG. 2 is a first functional block diagram of the document search system structured by the PC 100. The document search system shown in FIG. 2 is intended to search for document information as a medical evidence of a medical finding (first medical finding) created by a medical doctor. The document search system includes: a medical finding input portion 12 corresponding to a first acquiring portion; a similar medical finding searching portion 14 corresponding to a first searching portion; a diagnosis prospect extracting portion 16; a keyword extending portion 18 corresponding to second and third acquiring portions; a document searching portion 20 corresponding to a second searching portion; a document display controller 22 corresponding to a display controller; a past report information retaining portion 24; a thesaurus and bilingual dictionary retaining portion 26; and a document retaining portion 28. In the hardware configuration of FIG. 1, these respective functional blocks are realized by making the CPU 101 operate a given program read from the HDD 103 and stored in the memory 102, for example, a program corresponding to the procedure of the after-mentioned flowchart, according to an operation of the operating portion 105. The document display controller 22 controls displaying information showing a processing content on the display screen of the monitor 106 as a display portion (visible display). The document display controller 22 may control a printing apparatus as the display portion to print the display information on a sheet such as a paper sheet (eternally visible display), or may make control an audio output apparatus such as a speaker as the display portion to output sound (audible display) according to the display information.

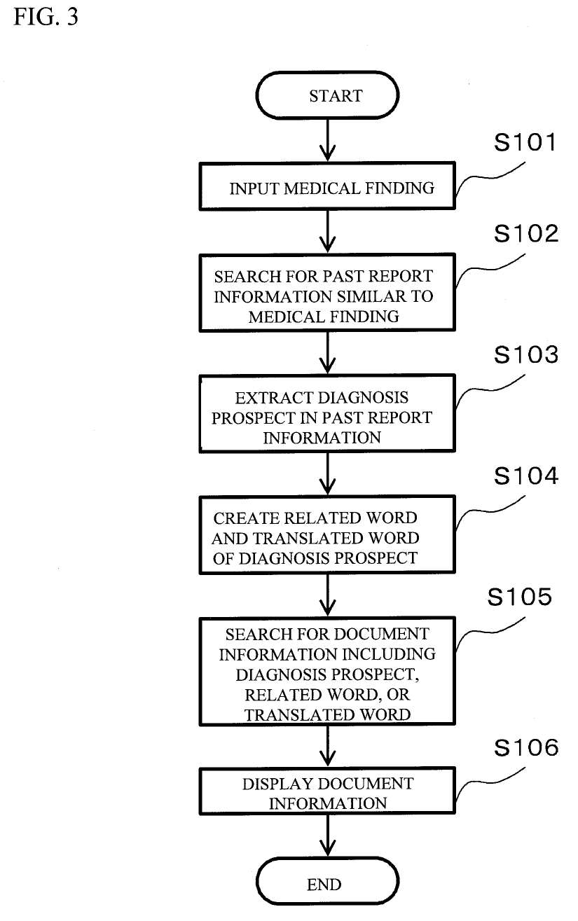

Operations of the document search system will be hereinafter described with reference to the flowchart. FIG. 3 is the flowchart showing the operations of the document search system.

By an operation of the operating portion 105 (keyboard or the like) by a medical doctor, the medical finding input portion 12 inputs a medical finding written with a free expression (S101). For example, when a radio surgeon interprets an MRI image, an input medical finding such as “In a FLAIR image T2 emphatic image, nodule or porphyritic high signals are widely shown in the pons, the bilateral thalamus, the radiate crown region, the bilateral white matter and the like” is input. The input medical finding is output to the similar medical finding searching portion 14.

The similar medical finding searching portion 14 executes natural sentence search for past report information retained in the past report information retaining portion 24 by using the input medical finding as a key, and thereby acquires past report information including a past medical finding (second medical finding) similar to the input medical finding (first medical finding) (S102).

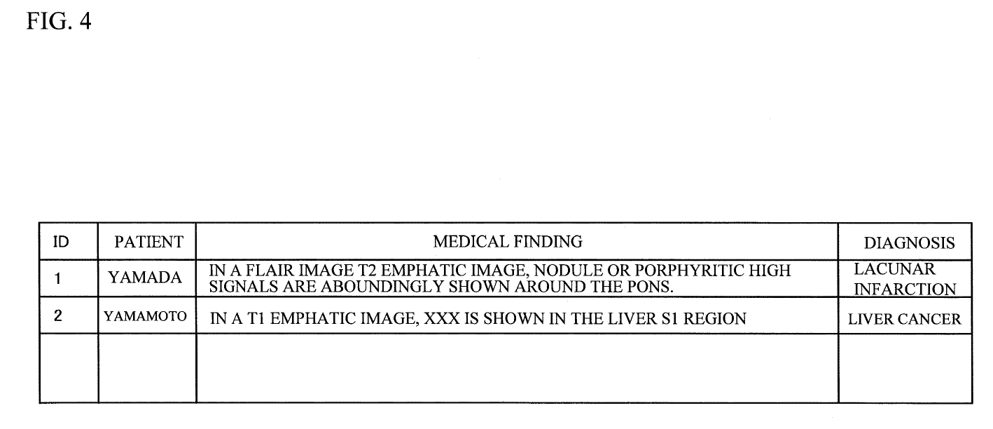

FIG. 4 is a diagram showing a first example of the past report information. The past report information shows medical findings prepared by the medical doctor in the past and diagnoses given according to the past medical findings. The past report information includes IDs for identifying the past report information, patient names, the medical findings prepared by the medical doctor in the past, and the diagnoses given according to the past medical findings. With the use of the search by the similar medical finding searching portion 14, the past report information showing what diagnosis was given by the medical doctor to the past medical finding similar to the input medical finding is acquired. For example, when the past report information shown in FIG. 4 is searched by using the foregoing input medical finding as a key, a past report of ID1, that is, the past report information in which the past medical finding is “In a FLAIR image T2 emphatic image, nodule or porphyritic high signals are aboundingly shown around the pons” and the diagnosis is “lacunar infarction” is acquired by the search.

The natural sentence search is realized as follows. That is, morphological analysis of the input medical finding is performed, and the input medical finding is divided in unit of word. Further, only important words are extracted. Full text search is made for the past medical findings in the past report information by using these important words as a key. The search target is not limited to the full text of the past medical findings, but may be part thereof. The past report information acquired by the search is output to the diagnosis prospect extracting portion 16.

The diagnosis prospect extracting portion 16 extracts the diagnosis in the input past report information as a prospect (S13). The extracted diagnosis is output to the keyword extending portion 18. The extracted diagnosis is the diagnosis given by the medical doctor based on the past medical finding similar to the input medical finding. Therefore, such an extracted diagnosis can be regarded as a diagnosis based on experiences of the medical doctor. However, at this point, it is not possible to determine that the extracted diagnosis has a medical evidence. Therefore, in the document search system, the document search is made by using the acquired diagnosis prospect as a key, and thereby document information as a medical evidence of the medical finding is acquired.

That is, the keyword extending portion 18 searches for a word related to the input diagnosis prospect (related word) and a word translated into a given language from the input diagnosis prospect (translated word) by using a thesaurus and a bilingual dictionary that are retained in the thesaurus and bilingual dictionary retaining portion 26 (S104).

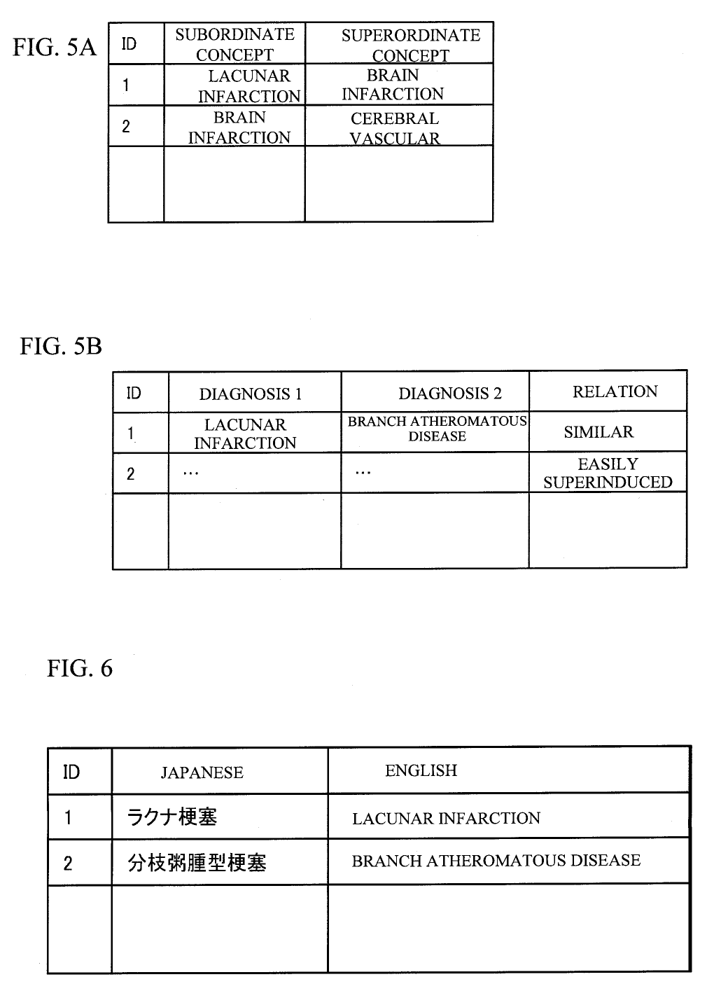

FIGS. 5A and 5B are diagrams showing an example of the thesaurus. The thesaurus shown in FIG. 5A shows words of the subordinate concept and words of the superordinate concept. Meanwhile, the thesaurus shown in FIG. 5B shows a plurality of diagnoses (in the figure, diagnosis 1 and diagnosis 2) and their relation (for example, a relation that the diagnosis 1 is similar to the diagnosis 2, a relation that the disease of the diagnosis 2 is often superinduced by the disease of the diagnosis 1). The keyword extending portion 18 determines the thesaurus including the diagnosis prospect, and extracts the word related to the diagnosis prospect in the thesaurus as a related word.

FIG. 6 is a diagram showing an example of the bilingual dictionary. In the bilingual dictionary shown in FIG. 6, a diagnosis in a given language (in this case, Japanese) and a diagnosis translated from the diagnosis into a language other than the given language (in this case, English) are shown in association with each other. The keyword extending portion 18 identifies the bilingual dictionary including the diagnosis prospect, and extracts the word corresponding to the diagnosis prospect in the bilingual dictionary as a translated word.

The related word and the translated word that are acquired by the keyword extending portion 18 are output to the document searching portion 20 together with the diagnosis prospect. The document searching portion 20 performs full text search for the document information retained in the document retaining portion 28 by using the diagnosis prospect, the related word, and the translated word as a keyword, and acquires document information having one of the diagnosis prospect, the related word, and the translated word as the document information as a medical evidence of the input medical finding (S105). The document information acquired by the search is output to the document display controller 22.

The document retaining portion 28 is a database in which document information related to the medical science is registered. The document retaining portion 28 does not necessarily exist inside the document search system, but may be connected to the document searching portion 20 via a network such as the Internet. The document retaining portion 28 desirably includes registered document information that is up to date as much as possible.

The document display controller 22 controls displaying the input document information on the monitor 106 (S106). The medical doctor reads the displayed document information and operates the operating portion 105, and thereby identifies the document information as a medical evidence of the medical finding, identifies the diagnosis, and adds a medical finding.

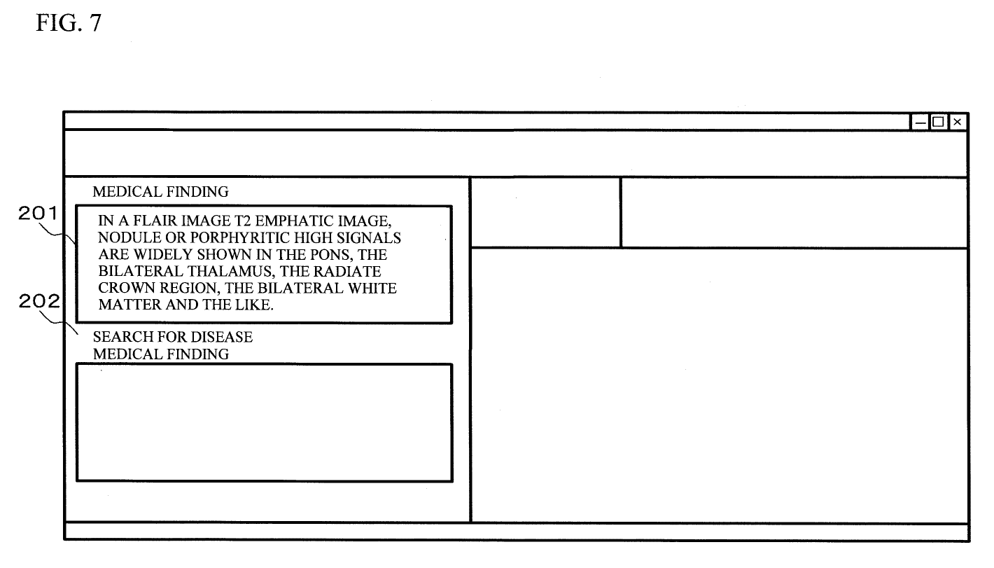

A description will be given of screen transition of the monitor 106 in the foregoing operations. FIG. 7 to FIG. 11 are views showing an example of the screen transition in the document search. As shown in FIG. 7, when the operating portion 105 (keyboard or the like) is operated by the medical doctor and the medical finding is prepared, the medical finding is displayed in a medical finding description space 201. Under the medical finding description space 201, a diagnosis search button region 202 for searching for a disease (diagnosis) is displayed.

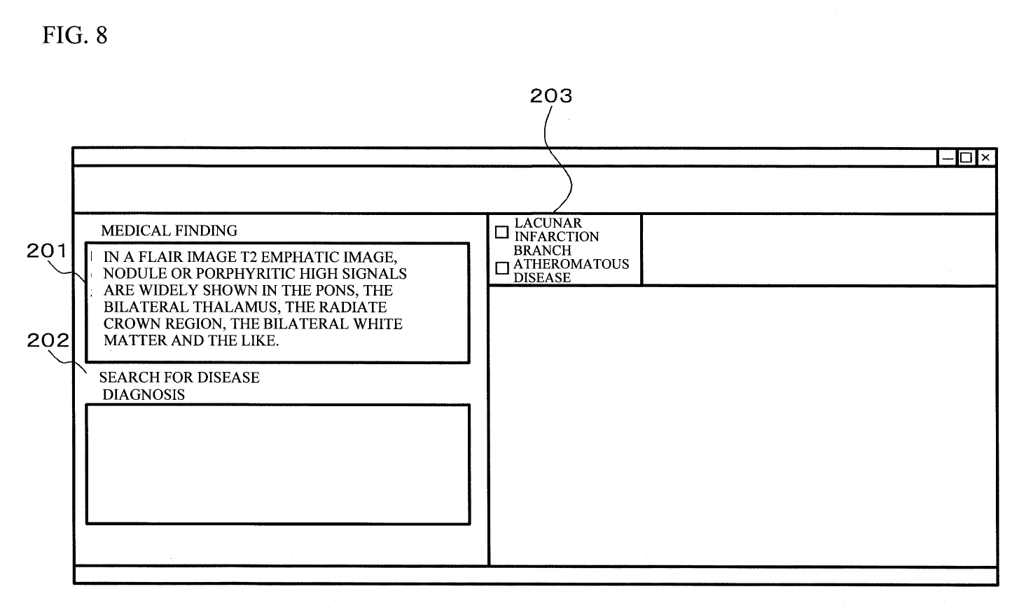

Then, when the operating portion 105 (mouse or the like) is operated by the medical doctor, and the diagnosis search button region 202 is selected by, for example, being clicked, the medical finding is input (S101 of FIG. 3), the past report information including the past medical finding similar to the input medical finding is acquired (S102), and the diagnosis prospect in the past report information is extracted (S103). Then, as shown in FIG. 8, the diagnosis prospects are displayed in a diagnosis prospect display space 203.

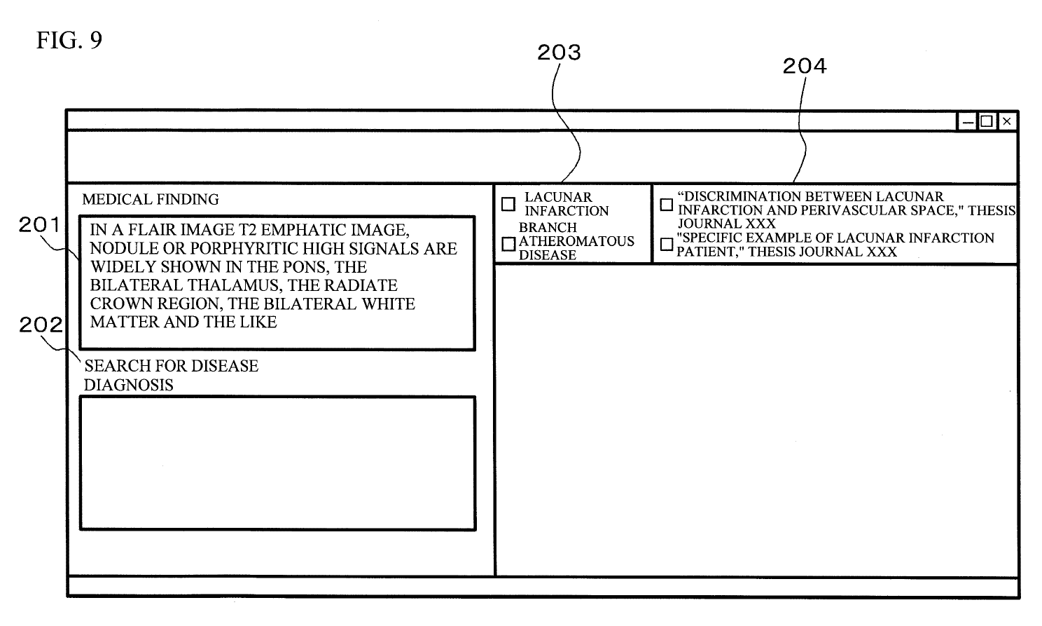

Further, the operating portion 105 (mouse or the like) is operated by the medical doctor, and one of the diagnosis prospects displayed in the diagnosis prospect display space 203 is selected by, for example, being clicked. Then, the related word and the translated word of the selected diagnosis prospect are created (S104 of FIG. 3), the document information including one of the diagnosis prospect, the related word, and the translated word is searched (S105), and the document information acquired by the search is displayed (S106). In result, as shown in FIG. 9, the document information (document titles in this case) is displayed in a document information display space 204.

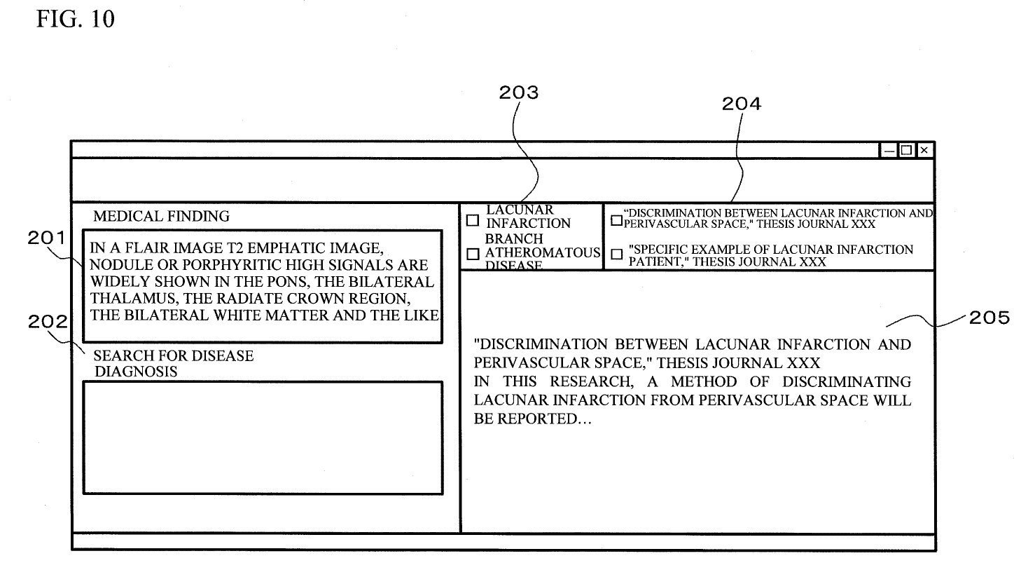

Next, the operating portion 105 (mouse or the like) is operated by the medical doctor, and one of the document information displayed in the document information display space 204 is selected by, for example, being clicked. Then, as shown in FIG. 10, the content of the document information is displayed in a document content display space 205.

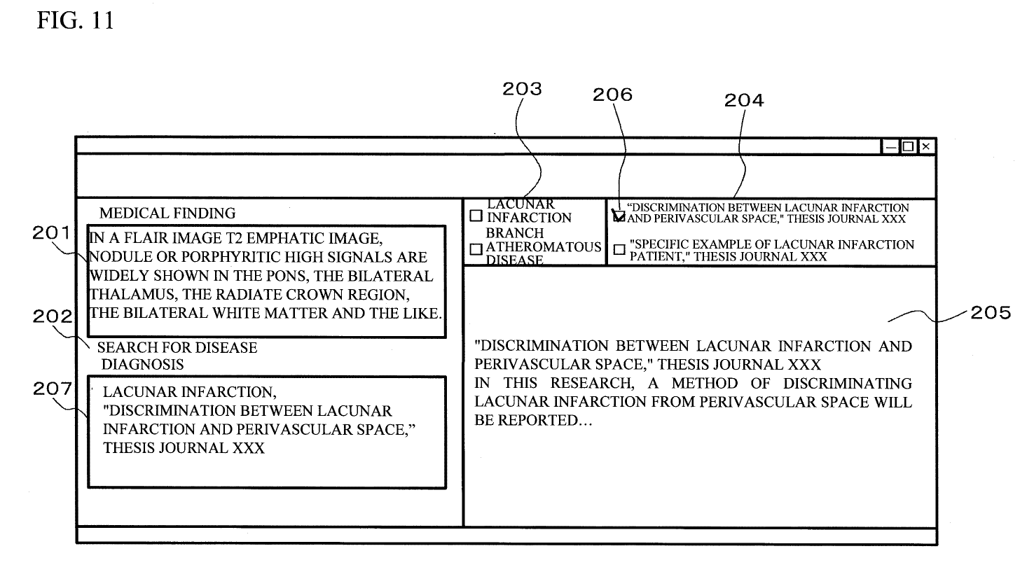

Further, if the operating portion 105 (mouse or the like) is operated by the medical doctor, and one of check spaces 206 in front of the document information in the document information display space 204 is selected by, for example, being clicked, it is possible that, as shown in FIG. 11, the diagnosis included in the checked document information, the title of the document information and the like may be automatically described in a diagnosis description space 207. Thereby, at least the medical finding and the diagnosis are matched and new past report information is created.

As above, in the document search system, when the medical doctor prepares the medical finding with the free expression (natural language sentence or the like), the diagnosis prospect in the past report information including the past medical finding similar to such a medical finding is extracted, the document information including one of the diagnosis prospect, the related word of the diagnosis prospect, and the translated word of the diagnosis prospect is searched, and thereby such document information is acquired as documented information as a medical evidence of the medical finding. As a result, the document information as a medical evidence of the medical finding can be appropriately searched.

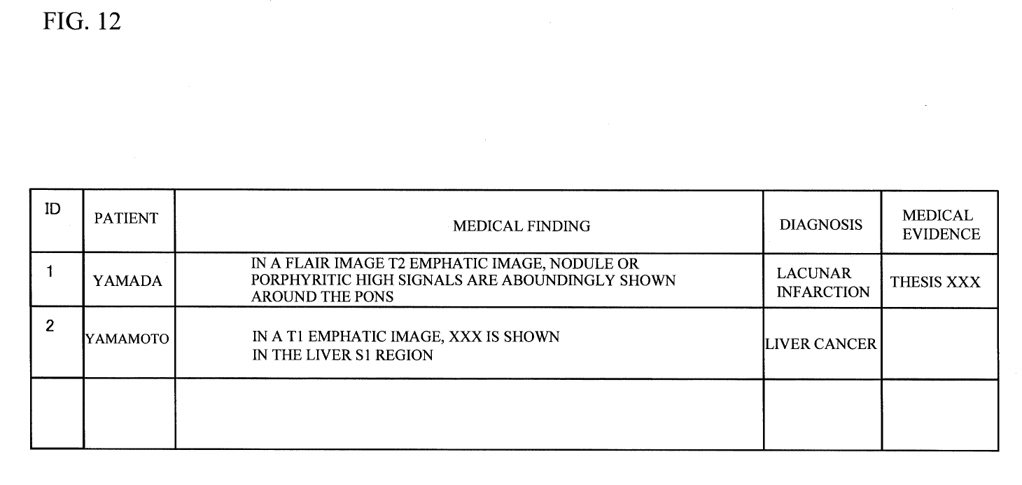

As shown in FIG. 12, the past report information may be added with document information as a medical evidence of the medical finding in the past report information. In this case, the past report information searched by the similar medical finding searching portion 14 is output to the document display controller 22 via the diagnosis prospect extracting portion 16, the keyword extending portion 18, and the document searching portion 20. The document display controller 22 controls displaying the document information in the input past report information on the monitor 106 as the document information acquired by the search by the document searching portion 20. Thereby, the document information as the medical evidence of the past medical finding, in other words, the document information familiar to the medical doctor is displayed and can be referred to by the medical doctor.

Further, the document information acquired by the search by the document searching portion 20 may be displayed in descending order of relevance degrees in relation to the input medical finding. In this case, the document searching portion 20 as a calculating portion acquires the medical finding input by the medical finding input portion 12 (input medical finding) via the similar medical finding searching portion 14, the diagnosis prospect extracting portion 16, and the keyword extending portion 18. Next, the document searching portion 20 calculates the relevance degree in relation to the input medical finding for every piece of document information acquired by searching for the document information retained in the document retaining portion 28. For example, the relevance degree is calculated by extracting a keyword of the input medical finding and a keyword of the document information respectively, and comparing these keywords to each other by spatial vector method. Then, the document searching portion 20 adds the calculated relevance degree to each piece of document information acquired by the search, and outputs the document information added with the relevance degree to the document display controller 22.

The document display controller 22 controls sorting out the document information added with the relevance degree in descending order of relevance degrees and display the sorted result on the monitor 106. Thereby, it is possible to display the document information according to the relevance degree. For example, the document information highly related to the input medical finding can be displayed preferentially. As a result, the medical doctor can efficiently acquire the document information as a medical evidence of the medical finding.

In a case where the past report information retained in the past report information retaining portion 24 is prepared by a plurality of medical doctors, expressions for the same diagnosis may be largely varied according to the preparer. This results in the possibility that appropriate document information is not able to be acquired. In this case, it is desirable that the input medical finding be input by using various expressions.

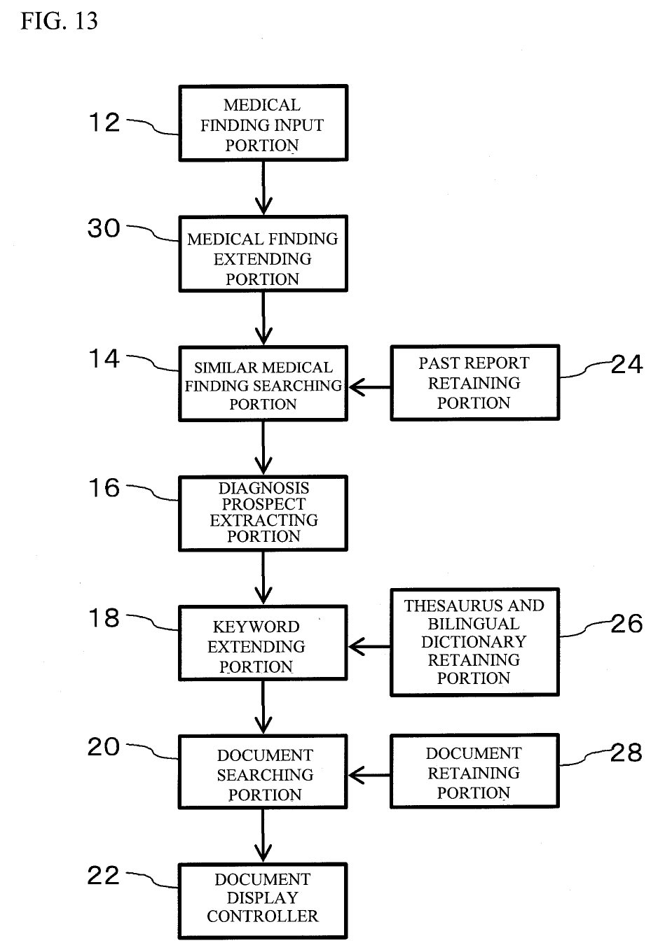

FIG. 13 is a second functional block diagram of the document search system structured by the PC 100. Compared to the document search system shown in FIG. 2, the document search system shown in FIG. 13 additionally has a medical finding extending portion 30 as a creating portion between the medical finding input section 12 and the similar medical finding searching portion 14.

The medical finding extending portion 30 creates a medical finding with a different expression in relation to the input medical finding (differently expressed medical finding). As a method of changing the expression, for example, a keyword in the input medical finding is extracted, and the keyword is substituted with a synonym or a paraphrastic word of the keyword. To acquire the synonym or the paraphrastic word of the keyword, it is necessary to prepare the similarity degree between the keyword and the synonym or the paraphrastic word. The similarity degree may be previously defined. Otherwise, the similarity degree may be realized by scoring the similarity degree between words included in medical findings of past report information that include the same diagnosis, out of the past report information retained in the past report information retaining portion 24. After that, the similar medical finding searching portion 14 executes natural sentence search for the past report information retained in the past report information retaining portion 24 by using the differently expressed medical finding as a key, and acquires past report information including a past medical finding similar to the differently expressed medical finding. As described above, by using various medical findings that have the same content with a different expression, the search range of the document information is widened, and thereby the document information as a medical evidence of the medical finding can be more appropriately searched for.

Further, the following method may be used. The document retaining portion 28 has the past report information or typical report information that has the same format as the past report information and serves as a model of document information. The past report information or the typical report information is acquired by search, and a portion thereof is further acquired as the input medical finding.

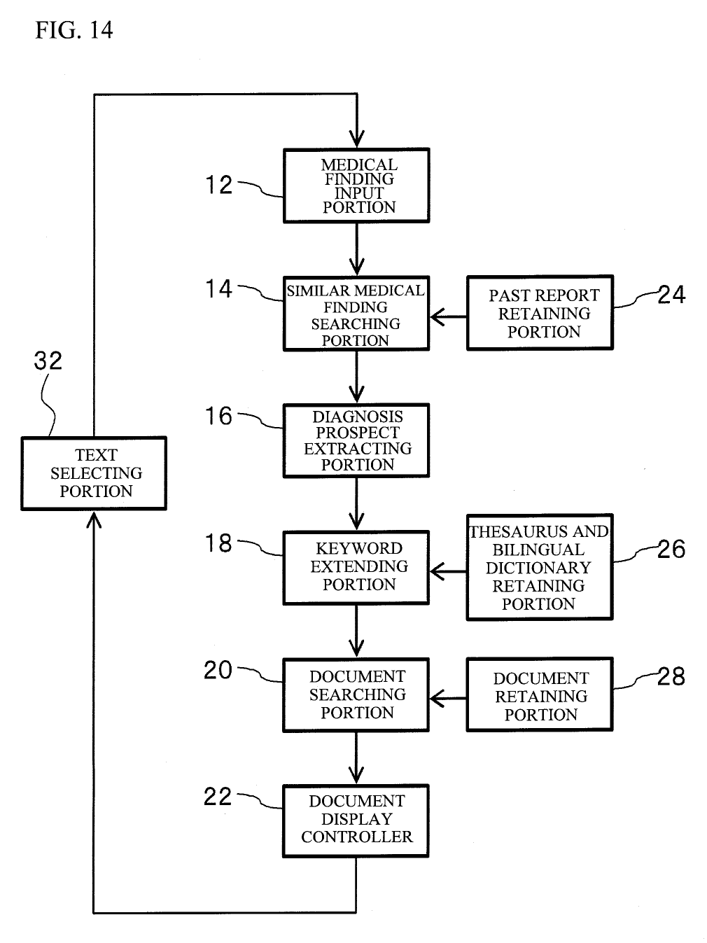

FIG. 14 is a third functional block diagram of the document search system structured by the PC 100. As compared to the document search system shown in FIG. 2, the document search system shown in FIG. 14 additionally has a text selecting portion 32 as a first acquiring portion between the document display controller 22 and the medical finding input portion 12.

The medical finding input portion 12 inputs the input medical finding by a medical doctor's operation of the operating portion 105 (keyboard or the like). After that, as in the foregoing description, the similar medical finding searching portion 14 searches the past report information including the past medical finding similar to the input medical finding, the diagnosis prospect extracting portion 16 extracts the diagnosis prospect in the past report information, and the keyword extending portion 18 acquires the related word and the translated word.

The document searching portion 20 performs full text search for the past report information or the typical report information as the document information retained in the document retaining portion 28 by use of the diagnosis prospect, the related word, and the translated word as a keyword, and acquires the information having one of the diagnosis prospect, the related word, and the translated word. The document display controller 22 controls displaying the input past report information or the input typical report information on the monitor 106, and outputs the past report information or the typical report information to the text selecting portion 32.

The text selecting portion 32 outputs a section selected by an operation of the operating portion 105 by the medical doctor (for example, a partial text of the medical finding) out of the input past report information or the input typical report information to the medical finding input portion 12. The medical finding input portion 12 adds the selected section to the input medical finding. After that, document search is performed by using the input medical finding added with the selected section. As described above, at least a portion of the past report information or a portion of the typical report information is acquired and added to the input medical finding. Thereby, the past report information or the typical report information acquired by the search can be reused for creating a new medical finding, and efficiency of creation of the medical finding can be improved.

In the foregoing exemplary embodiment, the document information is searched by using the diagnosis prospect in the past report information, the related word of the diagnosis prospect, and the translated word of the diagnosis prospect as a keyword. However, it is also possible that the document information is searched by using a word other than the diagnosis prospect included in the past report information, the related word of the word, and the translated word of the word as a keyword.

A document search method employed according to an aspect of the present invention is performed with a Central Processing Unit (CPU), Read Only Memory (ROM), Random Access Memory (RAM), and the like, by installing a program from a portable memory device or a storage device such as a hard disc device, CD-ROM, DVD, or a flexible disc or downloading the program through a communications line. Then the steps of program are executed as the CPU operates the program.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

### CROSS-REFERENCE TO RELATED APPLICATIONS

This application is based on and claims priority under 35 USC 119 from Japanese Patent Application No. 2006-194923 filed Jul. 14, 2006.

What is claimed is:

1. A document search system comprising:
a first acquiring portion that acquires a first medical finding;
a first searching portion that searches past report information for a second medical finding similar to the first medical finding acquired by the first acquiring portion, the past report information including the second medical finding and a corresponding word of the second medical finding, which is a word defined for the second medical finding;
a second searching portion that searches for document information that includes the corresponding word of the second medical finding included in the past report information searched by the first searching portion, the document information being a medical evidence of the first medical finding; and
a display controller that displays on a display portion, the document information searched by the second searching portion.

2. The document search system according to claim 1, further comprising a second acquiring portion that acquires a related word having a given relation to the corresponding word of the second medical finding included in the past report information searched by the first searching portion,
wherein the second searching portion searches for document information that has the related word acquired by the second acquiring portion.

3. The document search system according to claim 1, further comprising a third acquiring portion that acquires a translated word that is translated into a given language from the corresponding word of the second medical finding included in the past report information searched by the first searching portion,
wherein the second searching portion searches for document information that has the translated word acquired by the third acquiring portion.

4. The document search system according to claim 1, wherein:
the past report information includes document information as a medical evidence of the second medical finding, and
the display controller displays on the display portion, the document information included in the past report information.

5. The document search system according to claim 1, further comprising a calculating portion that calculates a relevance degree between the document information searched by the second searching portion and the first medical finding acquired by the first acquiring portion,
wherein the display controller displays on the display portion, the document information searched by the second searching portion in a display manner corresponding to the relevance degree calculated by the calculating portion.

6. The document search system according to claim 1, further comprising a creating portion that creates another first medical finding written in a different expression from that of the first medical finding acquired by the first acquiring portion,
wherein the first searching portion searches the past report information for the second medical finding similar to the first medical finding written in a different expression, created by the creating portion.

7. The document search system according to claim 1, wherein the first acquiring portion acquires at least a portion of the document information searched by the second searching portion with the first medical finding, and adds said at least the portion of the document information searched by the second searching portion to the first medical finding.

8. The document search system according to claim 1, wherein the corresponding word of the second medical finding is a diagnosis defined for the second medical finding.

9. A document search method comprising:
acquiring a first medical finding;
searching past report information for a second medical finding similar to the first medical finding acquired, the past report information including the second medical finding and a corresponding word of the second medical finding, which is a word defined for the second medical finding;
searching for document information that includes the corresponding word of the second medical finding included in the past report information searched, the document information being a medical evidence of the first medical finding; and
displaying on a display portion, the document information searched.

10. A computer readable medium storing a program causing a computer to execute a process for document search, the process comprising:
acquiring a first medical finding;
searching past report information for a second medical finding similar to the first medical finding acquired, the past report information including the second medical finding and a corresponding word of the second medical finding, which is a word defined for the second medical finding;
searching for document information that includes the corresponding word of the second medical finding included in the past report information searched, the document information being a medical evidence of the first medical finding; and
displaying on a display portion, the document information searched.
